(19) United States
(12) Patent Application Publication
(10) Pub. No.: US 2013/0088629 A1
(43) Pub. Date: Apr. 11, 2013

(54) MOBILE DEVICE AND METHOD OF REMOTELY CONTROLLING A CONTROLLED DEVICE

(71) Applicant: So-hyun RYU, Hwaseong-si (KR)

(72) Inventor: So-hyun RYU, Hwaseong-si (KR)

(73) Assignee: SAMSUNG ELECTRONICS CO., LTD., Suwon-si (KR)

(21) Appl. No.: 13/618,120

(22) Filed: Sep. 14, 2012

(30) Foreign Application Priority Data
Oct. 6, 2011 (KR) 10-2011-0101826

(51) Int. Cl. H04N 5/225

(52) U.S. Cl. 348/333.01; 348/E05.024

(57) ABSTRACT

A mobile device and a control method are disclosed. The mobile device including: a communication unit which communicates with a controlled device that displays a screen; a camera which captures an image of the screen of the controlled device; a display unit which displays an image taken from the screen of the controlled device; a touch input unit which receives a user's touch input to the display unit; and a controller which determines an area of the screen of the controlled device from the captured image, and transmits to the controlled device location information which corresponds to the user's touch input to an area of the screen. With this configuration, users can more conveniently remotely control a controlled device and interact with a UI provided by the controlled device, through a mobile device by touch.

### CROSS-REFERENCE TO RELATED APPLICATION

This application claims priority from Korean Patent Application No. 10-2011-0101826, filed on Oct. 6, 2011 in the Korean Intellectual Property Office, the disclosure of which is incorporated herein by reference.

### BACKGROUND

1. Field

Apparatuses and methods consistent with the exemplary embodiments relate to a mobile device and a control method thereof. More particularly, the exemplary embodiments relate to a mobile device and a control method thereof which is capable of communicating with a display apparatus displaying a user interface (UI) on a screen.

2. Description of the Related Art

A display apparatus such as a TV, a PC or an AV system, which displays an image thereon may display a user interface (UI) on a screen and operate according to a user command that is received through the UI. The UI may be remotely manipulated by a remote controller or may include a touchable UI which is touched by a user for a more useful manipulation.

When a user is close to a display apparatus, he/she may touch the UI. However, in a distant place, he/she may not use the touchable UI. Accordingly, due to the distance restriction, the touchable UI has not been used to control a controlled device such as a display apparatus targeted in a remote location, until now.

Wide-spread use of mobile devices such as mobile phones, smart phones and smart pads increases utilization of the mobile devices. The mobile devices have various functions including communicating with a display apparatus and transmitting and receiving data to/from the display apparatus. The mobile devices may include a camera which captures an image and a display unit which displays the captured image thereon.

### SUMMARY

Accordingly, one or more exemplary embodiments provide a mobile device and a control method thereof which more conveniently remotely controls a controlled device.

Further, one or more exemplary embodiments provide a mobile device and a control method thereof which enables a touchable interaction with a user interface (UI) provided by a controlled device.

The foregoing and/or other aspects may be achieved by providing a mobile device including: a communication unit which communicates with a controlled device that displays a screen; a camera which captures an image of the screen of the controlled device; a display unit which displays an image taken from the screen of the controlled device; a touch input unit which receives a user's touch input to the display unit; and a controller which determines an area of the screen of the controlled device from the taken image, and transmits to the controlled device location information which corresponds to the user's touch input to an area of the screen.

The controller may determine an area of the screen based upon a marker which is provided in the controlled device.

The controller may determine an area of the screen by performing an image recognition with respect to the taken image.

The communication unit may receive a sync signal from the controlled device, and the controller may determine an area of the screen based on a relative location of the controlled device, by using the received sync signal.

The location information which corresponds to the user's touch input may include coordinate information of a place which corresponds to the user's touch input with respect to a predetermined reference place of an area of the screen.

The controller may display on the display unit a UI which identifies a location which corresponds to the user's touch input.

The controller may adjust at least one of an angle and a zoom of the camera to display an area of the screen, when an image is taken from the screen.

The foregoing and/or other aspects may be achieved by providing a method of controlling a mobile device, the control method including: capturing with a camera, an image of a screen of a controlled device which displays the image on the screen; displaying on a display unit the image taken from the screen of the controlled device; receiving a user's touch input on the display unit; and determining an area of the screen of the controlled device from the taken image, and transmitting to the controlled device location information which corresponds to the user's touch input to an area of the screen.

The determining may include determining an area of the screen based upon a marker which is provided in the controlled device.

The determining may include determining an area of the screen by performing an image recognition with respect to the captured image.

The determining may include determining an area of the screen based on a relative location of the controlled device by using a sync signal received from the controlled device.

The location information which corresponds to the user's touch input may include coordinate information of a location which corresponds to the user's touch input to a predetermined reference place of an area of the screen.

The control method may further include displaying on the display unit, a UI which identifies a location which corresponds to the user's touch input.

The capturing of the image may include adjusting at least one of an angle and a zoom of the camera to display an area of the screen.

Another aspect of the inventive concept may provide a mobile device including a camera which captures an image of a screen of a controlled device, a display unit which displays the captured image, an input unit which receives a user's input to the display unit, and a controller which determines an area of the screen of the controlled device from the captured image, and transmits to the controlled device the location information which corresponds to the user's input.

A further aspect of the inventive concept may provide a method of controlling a mobile device, the method including capturing with a camera an image of a screen of a controlled device displaying on a display unit the captured image, receiving a user's input to the display unit, and determining an area of the screen of the controlled device and transmitting to the controlled device the location the information which corresponds to the user's input to the area of the screen.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 illustrates a controlled device and a mobile device according to an exemplary embodiment of the present inventive concept;

FIG. 2 is a block diagram of the mobile device of FIG. 1;

FIG. 3 is a flowchart of a method of controlling the mobile device of FIGS. 1 and 2;

FIG. 4 illustrates a controlled device which displays a user interface (UI) on a screen and a mobile device which displays thereon an image taken from the screen;

FIG. 5 illustrates an area of a screen of the controlled device that is displayed in the mobile device;

FIG. 6 illustrates another example of a controlled device which displays a UI on a screen and a mobile device which displays thereon an image taken from the screen; and

FIG. 7 illustrates a controlled device which receives location information from the mobile device and displays a UI on a screen.

### DETAILED DESCRIPTION OF EXEMPLARY EMBODIMENTS

Below, exemplary embodiments will be described in detail with reference to accompanying drawings so as to be easily understood by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

Hereinafter, an exemplary embodiment of the present inventive concept will be described in detail.

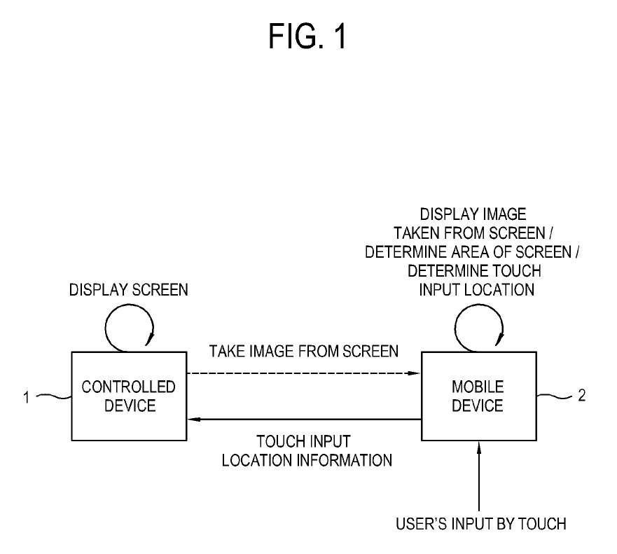

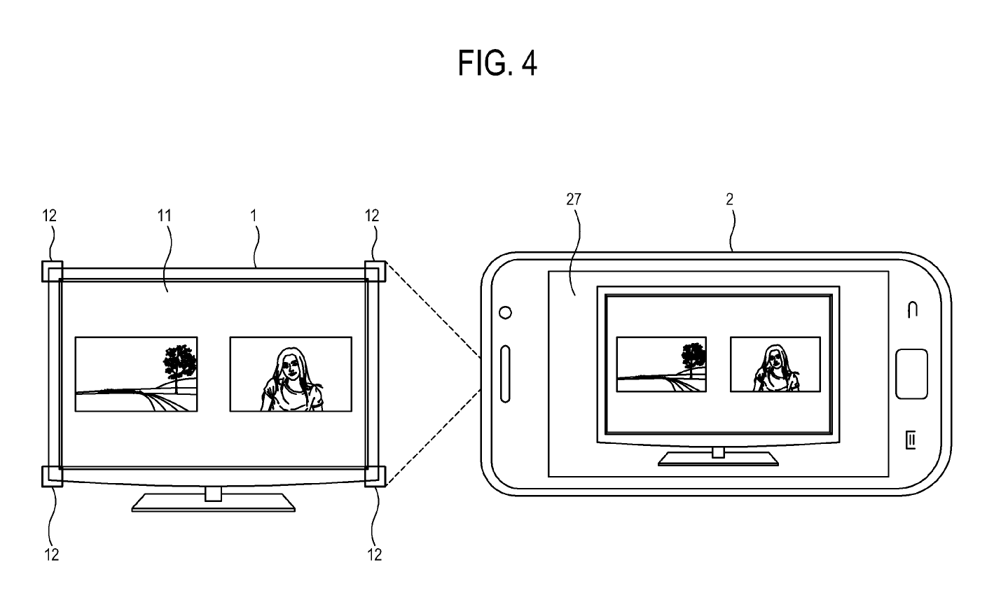

FIG. 1 illustrates a controlled device and a mobile device according to an exemplary embodiment of the present inventive concept. The controlled device 1 may include a display apparatus which displays an image thereon such as a TV, a PC or an AV system. The controlled device 1 operates according to user commands and displays a user interface (UI) on a screen to receive a user's command (refer to reference numeral 11 in FIG. 4).

The mobile device 2 may include a mobile phone, a smart phone or a smart pad. The mobile device 2 provides an image-taking function, a touch input function and a communication function. The mobile device 2 provides a user with an image 27 (refer to FIG. 4) which is taken from a screen 11 of a controlled device 1, which displays a UI. A user touches the UI of the screen 11 of the controlled device 1 by touching the image displayed on the mobile device 2. The mobile device 2 correlates a touched location of the UI of the screen 11 of the controlled device 1, and transmits the location information to the controlled device 1. The controlled device 1 identifies a user's command based on the information on the touched location transmitted by the mobile device 2, and performs an operation according to the transmitted information.

As above, according to an exemplary embodiment of the present inventive concept, a user may control the controlled device 1 by touching the UI of the controlled device 1 through the use of the mobile device 2 and control the controlled device 1 which is at a remote place without limitation as to the distance between the controlled device 1 and a user, to thereby ensure user convenience.

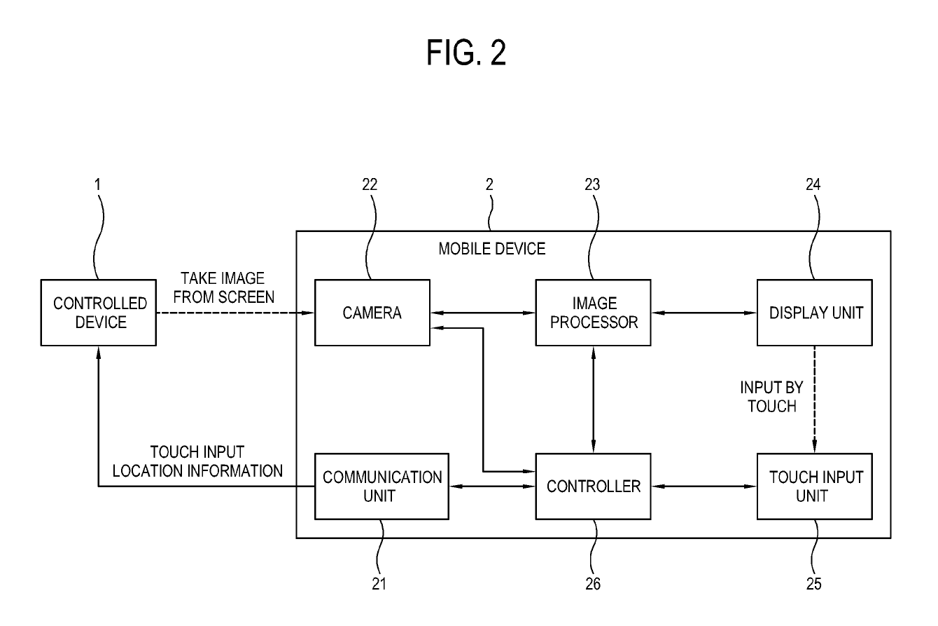

FIG. 2 is a block diagram of the mobile device 2 which is shown in FIG. 1. As shown therein, the mobile device 2 includes a communication unit 21, a camera 22, an image processor 23, a display unit 24, a touch input unit 25 and a controller 26.

The communication unit 21 communicates with the controlled device 1. The communication unit 21 transmits to the controlled device 1 location information relating to a user's touch input. Communication between the communication unit 21 and the controlled device 1 varies, including both wired and wireless communications.

The camera 22 captures an image of the screen 11 of the controlled device 1.

The image processor 23 processes an image 27 of the screen 11 of the controlled device 1 that is taken by the camera 22, to display the image 27 on the display unit 24.

The display unit 24 displays thereon the image 27 of the screen 11 of the controlled device 1 that is processed by the image processor 23. The display unit 24 can vary by including a liquid crystal display (LCD) and an organic light emitting diode (OLED).

The touch input unit 25 receives a user's touch input to the display unit 25, which displays thereon the image 27 of the screen 11 of the controlled device 1. The user's touch input varies and can include tapping, multi-tapping, dragging, sliding, and making a gesture.

The controller 26 performs an overall control operation for the mobile device 2. The controller 26 controls the camera 22 to capture an image according to a user command. The controller 26 controls the image processor 23 to display the image 27 of the screen 11 of the controlled device 1 that is captured by the camera, on the display unit 24. Upon receiving a user's touch input through the touch input unit 25, the controller 26 controls identification of location information of the touch input and controls transmission of the identified location information to the controlled device 1, through the communication unit 21.

The controller 26 may include a control program to perform the control operations, a non-volatile memory (not shown) which stores therein the control program to perform the control operations, a volatile memory (not shown) which loads at least a part of the stored control program, and a microprocessor (not shown) which executes the loaded control program.

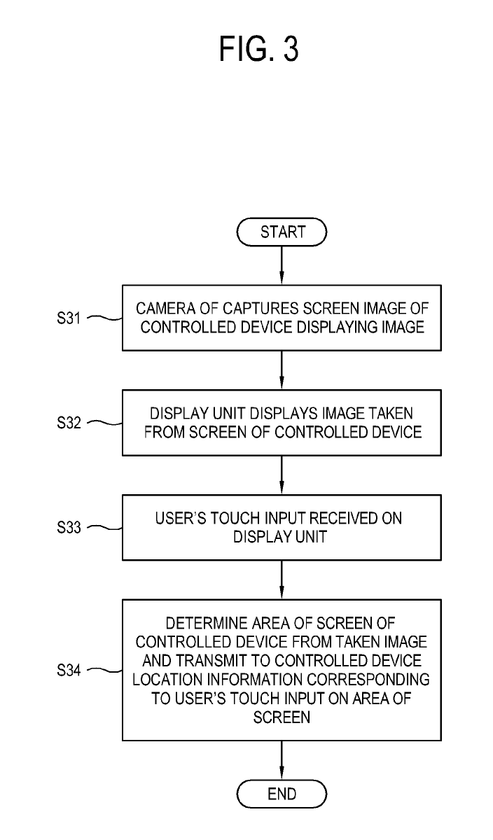

FIG. 3 is a flowchart of a control method of the mobile device 2 which is shown in FIGS. 1 and 2. FIG. 4 illustrates the controlled device 1 which displays a UI on the screen 11, and the mobile device 2 which displays thereon the image 27 that is taken from the screen 11.

Referring to FIGS. 3 and 4, the mobile device 2 uses camera 21 (S31) to capture an image of the screen 11 of the controlled device 1 that displays a UI. Capturing the image of the screen 11 of the controlled device 1 may be performed according to a user command. For example, a user may adjust a focus of the camera 22 of the mobile device 2 which corresponds to the screen 11 of the controlled device 1, operate a shutter and take an image of the screen 11. Otherwise, taking the image of the screen 11 of the controlled device 1 may be performed automatically. For example, the controller 26 may identify whether the focus of the camera 21 corresponds to the screen 11 of the controlled device 1 and capture an image automatically if the focus corresponds to the screen 11. The determination of whether the focus of the camera 21 corresponds to the screen 11 of the controlled device 1 will be described later, in more detail. The focus of the camera 21 may be adjusted by a control of the controller 26. For example, the camera 21 may be shifted a predetermined distance or turned at a predetermined angle with respect to a main body of the mobile device 2. The camera 21 may zoom in or zoom out according to a control of the controller 26.

The mobile device 2 displays on the display unit 24 the image 27 which is taken from the screen 11 of the controlled device 1 (S32).

The mobile device 2 receives a user touch input to the display unit 24 through the touch input unit 25 (S33).

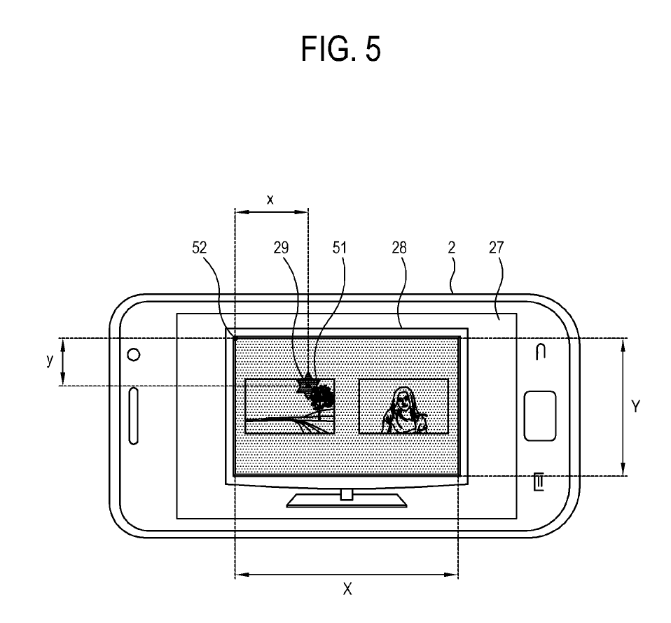

The mobile device 2 determines an area 28 (refer to FIG. 5) of the screen 11 of the controlled device 1 from the image 27 that is taken, identifies the location which corresponds to the user's touch input to an area 28 of the screen 11 of the controlled device 1, and transmits the location information to the controlled device 1.

An area 28 of the screen 11 of the controlled device 1 from the taken image 27 may be determined by using one of various methods. For example, an area 28 of the screen 11 of the controlled device 1 may be determined on the basis of a marker 12 (refer to FIG. 4) which is provided in the controlled device 1. The marker 12 may include an infrared reflection sheet. In this case, the mobile device 2 may further include an infrared sensor (not shown). The controller 26 may detect infrared rays that are reflected by the marker 12 through the infrared sensor and identify an area 28 of the screen 11 of the controlled device 1. The marker 12 may be provided in a location at which it is easy to identify an area 28 of the screen 11 of the controlled device 1. For example, the marker 12 may be provided in each of four edges of a rectangular screen 11 of the controlled device 1. The shape and location of the marker 12 shown in FIG. 4 is an example that is provided for purposes of convenience. Embodiments of the marker 12 may be different and may vary as would be understood by someone with ordinary knowledge of the art.

As described above, determining whether the focus of the camera 22 corresponds to the screen 11 of the controlled device 1 may be performed by detecting infrared rays reflected by the marker 12. If the focus of the camera 22 does not correspond to the screen 11 of the controlled device 1, the controller 26 may adjust the focus of the camera 22, e.g., adjust angle or a zoom of the camera 22 to ensure correspondence therebetween. The image 27 in FIG. 4 is an example of an optimum focus of the camera 22, and at that timing, the entire area 28 of the screen 11 of the controlled device 1 is displayed on the display unit 24.

Determination on an area 28 of the screen 11 of the controlled device 1 may vary including using the marker 12 as above. For example, the determination on an area 28 of the screen 11 of the controlled device 1 may be performed by image recognition of the image 27 that is captured. That is, a predetermined image recognition algorithm may be applied to determine an area 28 which is determined as the screen 11 of the controlled device 1, in connection with the captured image 27. The image recognition may include, e.g., an edge detection. Determination on an area 28 of the screen 11 of the controlled device 1 may be otherwise performed as follows: a sync signal is received at a predetermined interval from the controlled device 1. A relative location of the controlled device 1 with respect to the mobile device 2 is identified by using the received sync signal. The identified relative location is used to determine an area 28 of the screen 1.

If the user's touch input to an area 28 of the screen 11 of the controlled device 1 is received, the mobile device 2 identifies the location which corresponds to the user's touch input to an area 28 of the screen 11 of the controlled device 1. FIG. 5 illustrates an area 28 of the screen 11 of the controlled device 1 displayed on the mobile device 1. Presumably, a user has touched a place or point 29 of an area 28 of the screen 11 shown in FIG. 5. The mobile device 2 determines a coordinate of the point 29 corresponding to the user's touch input to an area 28 of the screen 11. The mobile device 2 may determine coordinates x and y of the point 29 which corresponds to the user's touch input based on an upper left edge 52 of the screen 11. The coordinates x and y of the point 29 which corresponds to the user's touch input may be determined in proportion to the size X and Y of an area 28 of the screen 11. The mobile device 2 transmits to the controlled device 1 coordinate information x, y, X and Y of the point 29 which corresponds to the determined user's touch input. The controlled device 1 performs a predetermined operation based on the received coordinate information x, y, X and Y of the point 29 which corresponds to the user's touch input. For example, as shown in FIG. 5, the controlled device 1 may determine that one of images displayed on the screen 11 has been selected as corresponding to the user's touch input.

Upon a user's touch input to an area 28 of the screen 11 of the controlled device 1, the mobile device 2 may display a UI 51 which identifies a touched location. Otherwise, upon a user's touch input by touch to an area 28 of the screen 11 of the controlled device 1, the mobile device 2 may respond through vibration to notify the validity of the user's touch.

According to the exemplary embodiment of the present inventive concept, a user may touch the virtual screen 11 of the controlled device 1 which is displayed through the image of the mobile device 2 and may control the controlled device 1 in a remote location to thereby be provided with a convenient and intuitive user environment, as if a user were touching the screen 11 of the controlled device 1.

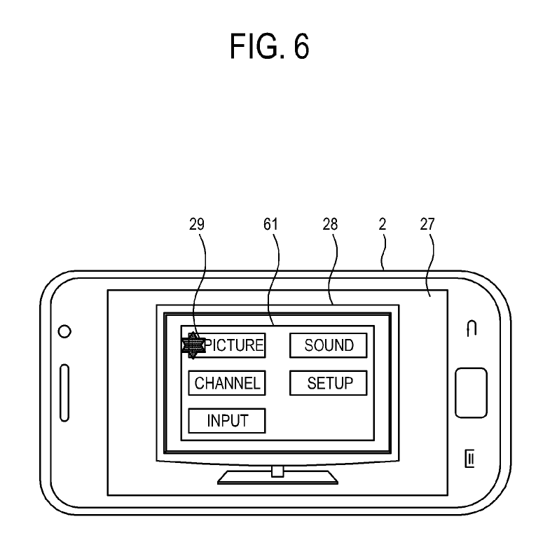

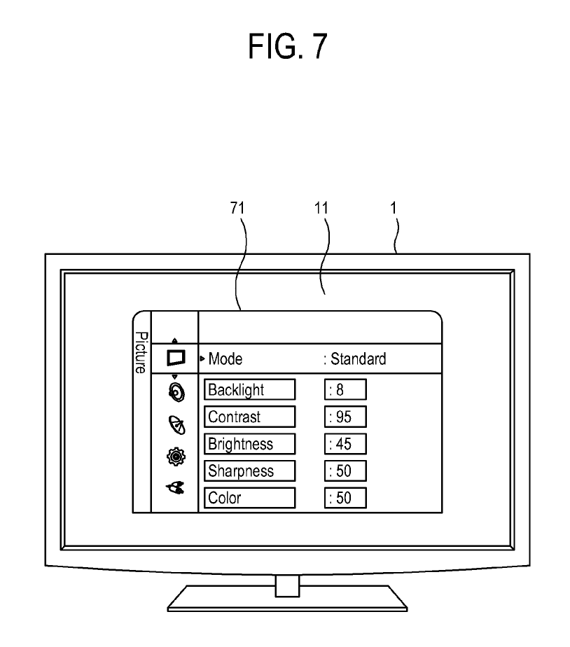

FIG. 6 illustrates another example of the controlled device 1 which displays a UI on the screen 11 and the mobile device 2 which displays an image taken from the screen 11. As shown therein, a UI 61 which corresponds to a TV menu is displayed on the screen 11 of the controlled device 1. The menu UI 61 may include, e.g., picture, sound, channel, setup and input items. A user may touch one of the items of the UI 61 from an area 28 of the screen 11 of the controlled device 1 displayed as the image 27 captured by the mobile device 2. For example, as shown in FIG. 6, a user may touch the picture item. The mobile device 2 then transmits to the controlled device 1 the coordinate information x, y, X and Y of the point 29 which corresponds to a user's touch input. The controlled device 1 determines that the picture item has been selected from items of the UI 61, based on the coordinate information x, y, X and Y of the point 29 which corresponds to the user's touch input. Then, the controlled device 1 displays a submenu UI corresponding to the picture item. FIG. 7 illustrates an example of the submenu UI 71 which corresponds to the picture item that is displayed on the screen 11 of the controlled device 1.

As described above, a mobile device and a control method thereof according to the present inventive concept enables a user's touch interaction with a UI provided by a controlled device through a mobile device, and enables a user to more conveniently remotely control the controlled device.

Although a few exemplary embodiments have been shown and described, it will be appreciated by those skilled in the art that changes may be made in these exemplary embodiments without departing from the principles and spirit of the invention, the range of which is defined in the appended claims and their equivalents.

What is claimed is:

1. A mobile device comprising:
a communication unit which communicates with a controlled device that displays a screen having an image;
a camera which captures an image of the screen of the controlled device;
a display unit which displays an image captured from the screen of the controlled device;
a touch input unit which receives a user's touch input to the display unit; and
a controller which determines an area of the screen of the controlled device from the captured image, and transmits to the controlled device the location information which corresponds to the user's touch input to the area of the screen.

2. The mobile device according to claim 1, wherein the controller determines the area of the screen based on a marker which is provided in the controlled device.

3. The mobile device according to claim 1, wherein the controller determines the area of the screen by performing an image recognition with respect to the captured image.

4. The mobile device according to claim 1, wherein the communication unit receives a sync signal from the controlled device, and the controller uses the received sync signal to determine the area of the screen based on a relative location of the controlled device.

5. The mobile device according to claim 1, wherein the location information which corresponds to the user's touch input comprises coordinate information of a location which corresponds to the user's touch input with respect to a predetermined reference place in the area of the screen.

6. The mobile device according to claim 1, wherein the controller displays a user interface (UI) on the display unit which identifies a location which corresponds to the user's touch input.

7. The mobile device according to claim 1, wherein the controller adjusts at least one of an angle and a zoom of the camera to display the area of the screen when an image is captured from the screen.

8. A method of controlling a mobile device, the control method comprising:
capturing an image with a camera of a screen of a controlled device which displays the screen;
displaying on a display unit the image captured from the screen of the controlled device;
receiving a user's touch input to the display unit; and
determining an area of the screen of the controlled device from the captured image and transmitting to the controlled device location information which corresponds to the user's touch input to the area of the screen.

9. The control method according to claim 8, wherein the determining comprises determining the area of the screen based on a marker which is provided in the controlled device.

10. The control method according to claim 8, wherein the determining comprises determining the area of the screen by performing an image recognition with respect to the captured image.

11. The control method according to claim 8, wherein the determining comprises determining the area of the screen based on a relative location of the controlled device by using a sync signal received from the controlled device.

12. The control method according to claim 8, wherein the location information which corresponds to the user's touch input comprises coordinate information of a location which corresponds to the user's touch input to a predetermined reference place of the area in the screen.

13. The control method according to claim 8, further comprising displaying a user interface (UI) on the display unit which identifies a location which corresponds to the user's touch input.

14. The control method according to claim 8, wherein the capturing the image comprises adjusting at least one of an angle and a zoom of the camera to display the area of the screen.

15. A mobile device comprising:
a camera which captures an image of a screen of a controlled device;
a display unit which displays the captured image;
an input unit which receives a user's input to the display unit; and
a controller which determines an area of the screen of the controlled device from the captured image, and transmits to the controlled device the location information which corresponds to the user's input.

16. The mobile device of claim 15, further comprising a communication unit which communicates with a controlled device that displays a screen having the image.

17. The mobile device of claim 15, wherein the user input is a touch input to the display unit.

18. A method of controlling a mobile device, the method comprising:
capturing an image with a camera;
displaying on a display unit the captured image;
receiving a user's input to the display unit; and
determining an area of the screen of the controlled device and transmitting to the controlled device the location information which corresponds to the user's input to the area of the screen.

19. The control method of claim 18, wherein the image is captured from a screen of the controlled device.

20. The control method of claim 18 wherein the user's input is a touch input to the display unit.
